(19) United States
(12) Patent Application Publication
(10) Pub. No.: US 2015/0298704 A1
(43) Pub. Date: Oct. 22, 2015

(54) HYBRID VEHICLE CONTROL APPARATUS

(71) Applicant: TOYOTA JIDOSHA KABUSHIKI KAISHA, Toyota-shi (JP)

(72) Inventor: Kenji ITAGAKI, Shizuoka-ken (JP)

(73) Assignee: TOYOTA JIDOSHA KABUSHIKI KAISHA, Toyota-shi (JP)

(21) Appl. No.: 14/690,674

(22) Filed: Apr. 20, 2015

(30) Foreign Application Priority Data
Apr. 22, 2014 (JP) 2014-088538

(51) Int. Cl. B60W 30/20; B60W 10/08; B60W 10/02; B60W 20/00

(52) U.S. Cl. CPC B60W 30/20; B60W 20/40; B60W 10/08; B60W 10/02; B60W 2030/206; B60W 2510/0275; B60W 2710/021; B60W 2710/08; Y10S 903/93

(57) ABSTRACT

A hybrid vehicle control apparatus configured to control a hybrid vehicle provided with an engagement mechanism realizing a fixed gear ratio mode in which rotation of an electrical rotating machine is limited in an engaged state in which a pair of engaging elements engage, is provided with: a determining device configured to determine whether or not a direction of torque acting on the engaging element of the engagement mechanism is reversed in fixed gear ratio engine brake traveling; and a controlling device configured to control the electrical rotating machine to set the electrical rotating machine to be in a shutdown state in the fixed gear ratio mode, and to temporarily release the shutdown control if it is determined that the direction of the torque is reversed, so that backlash elimination torque is supplied for eliminating backlash formed between the pair of engaging elements.

### CROSS-REFERENCE TO RELATED APPLICATIONS

This application is based upon and claims the benefit of priority of the prior Japanese Patent Application No. 2014-088538, file on Apr. 22, 2014, the entire contents of which are incorporated herein by reference.

### BACKGROUND OF THE INVENTION

1. Field of the Invention

The present invention relates to a control apparatus for a hybrid vehicle.

2. Description of the Related Art

There is known a hybrid vehicle provided with a so-called continuously variable transmission (CVT) mode, in which an engine and an electrical rotating machine are coupled with a differential mechanism and in which reaction torque countering engine torque is received or born by the electrical rotating machine, thereby controlling an engine operating point. Moreover, in this type of hybrid vehicle, there is also known a configuration thereof provided with a so-called fixed gear ratio mode, in which one rotating element of the differential mechanism can be set non-rotatable by an engagement mechanism provided with a pair of engaging elements and in which the reaction torque is received or born by the engagement mechanism, thereby fixing a transmission gear ratio (refer to Patent Literature 1).

Moreover, it is also proposed that, when power running torque or regenerative torque by two electric motors are transmitted to drive wheels, the torque is outputted by a first electric motor MG1 and is then outputted by a second electric motor MG2, thereby suppressing a reduction in drivability associated with elimination of backlash or play (refer to Patent Literature 2).

As an apparatus related to the backlash, there is also proposed an apparatus configured to suppress rattling shock or chattering shock by differentiating a first change timing at which torque of a first driving force generating source (or engine) is increased, and a second change timing at which torque of the second motor generator MG2 is increased (refer to Patent Literature 3).

Moreover, it is also proposed that, if it is determined to be in a driven state in which an engine driving system is driven by the drive wheels, the second motor generator MG2 is driven and controlled, and the elimination of the backlash is performed on a drive side of a motor driving system that is from the second motor generator MG2 to the drive wheels (refer to Patent Literature 4).

Moreover, it is also proposed that if the torque of the electric motor changes between positive torque and negative torque with them centered around zero, a variation in the torque of the electric motor per unit time is controlled to be less than or equal to a predetermined value (refer to Patent Literature 5).

### CITATION LIST

### Patent Literature

### Patent Literature 1: Japanese Patent Application Laid Open No. 2010-137802

### Patent Literature 2: Japanese Patent Application Laid Open No. 2013-169852

### Patent Literature 3: Japanese Patent Application Laid Open No. 2008-189206

### Patent Literature 4: Japanese Patent Application Laid Open No. 2007-159360

### Patent Literature 5: Japanese Patent Application Laid Open No. 2004-254434

In traveling in a fixed gear ratio mode (hereafter expressed as “in fixed gear ratio traveling” as occasion demands), engine brake is required in some cases. In this case, the engine is set to be in a fuel cut state, and the engine is set to be in the driven state by a driving force from the drive wheels. Therefore, as engagement torque that enables the pair of engaging elements to be engaged with each other, friction torque of the engine acts on the engaging element corresponding to the rotating element to be fixed.

Here, as this type of engagement mechanism, a meshing type engagement mechanism such as, for example, a dog clutch which is excellent in power transmission efficiency is preferably used. In the meshing type engagement mechanism, meshing members formed in the pair of engaging elements mesh with each other, thereby establishing the engagement. Moreover, in the meshing type engagement mechanism, the backlash or play is formed between the meshing members of the engaging elements for the purpose of relatively facilitating the engagement and disengagement of the pair of engaging elements. In engine brake traveling in the fixed gear ratio traveling (hereinafter expressed as “in fixed gear ratio engine brake traveling” as occasion demands), the backlash is eliminated by the aforementioned engagement torque.

By the way, in the fixed gear ratio engine brake traveling, a direction of the engagement torque is reversed in some cases. The reverse of the direction of the engagement torque causes so-called rattling in which the meshing members formed in the engaging elements collide with each other, and vibration referred to as rattling shock and noise referred to as rattling sound cause drivability to be reduced.

Here, particularly in the hybrid vehicle, such control that the electrical rotating machine is set to be in a shutdown state in the fixed gear ratio traveling is widely used for the purpose of saving power consumption. The shutdown state means a state in which electrification is all stopped, including switching drive of an inverter. In the fixed gear ratio traveling, therefore, rotational resistance corresponding to inertia is only generated in the electrical rotating machine, and the electrical rotating machine does not function as a device configured to suppress the vibration and noise caused by the rattling.

In the aforementioned Patent Literatures, the elimination of the backlash in the fixed gear ratio engine brake traveling as described above is not considered, and presence thereof is not even implied. In conventional technologies, namely, it is hard to avoid the generation of the vibration and noise caused by the rattling in the fixed gear ratio engine brake traveling, which is technically problematic.

### SUMMARY OF THE INVENTION

In view of the technical problems according to the present invention, it is therefore an object of the present invention to provide a hybrid vehicle control apparatus configured to suppress the vibration and noise caused by the rattling in the fixed gear ratio engine brake traveling.

The above object of the present invention can be achieved by a hybrid vehicle control apparatus configured to control a hybrid vehicle is provided with: an engine; an electrical rotating machine; a drive shaft connected to drive wheels; a differential mechanism comprising a plurality of rotating elements that perform a differential action on each other, including rotating elements each of which is coupled with the engine, the electrical rotating element, or the drive shaft; and an engagement mechanism comprising a pair of engaging elements of a meshing type, one of which is coupled with one of the plurality of rotating elements and another of which is coupled with a fixed element, the engagement mechanism realizing a fixed gear ratio mode in which rotation of the electrical rotating machine is limited in an engaged state in which the pair of engaging elements engage, said hybrid vehicle control apparatus is provided with: a determining device configured to determine whether or not a direction of torque acting on the one engaging element is reversed if engine brake traveling with fuel cut of the engine is performed in the fixed gear ratio mode; and a controlling device configured to control the electrical rotating machine to perform shutdown control for setting the electrical rotating machine to be in a shutdown state in the fixed gear ratio mode, and to temporarily release the shutdown control if it is determined that the direction of the torque is reversed, so that backlash elimination torque is supplied for eliminating backlash formed between the pair of engaging elements (claim 1).

The engagement mechanism according to the present invention is provided with the pair of engaging elements of the meshing type, one of which is coupled with the one rotating element of the differential mechanism and another of which is coupled with the fixed element such as, for example, a transmission case. The one rotating element is one of remaining rotating elements, except a rotating element coupled with the engine and a rotating element coupled with the drive shaft. The engagement mechanism can limit the rotation of the electrical rotating machine by fixing the one rotating element in a non-rotatable manner in the engaged state in which the pair of engaging elements engage.

At this time, if the one rotating element is a rotating element coupled with the electrical rotating element, the electrical rotating element becomes non-rotatable, and one example of the limit of the rotation is realized. Moreover, for example, if the differential mechanism is formed by a combination of a plurality of differential mechanisms or in similar cases, the one rotating element can be set as a rotating element other than the rotating elements coupled with the electrical rotating element, the engine, and the drive shaft. In this case, the rotation of the electrical rotating machine is fixed at one number of revolutions determined by a gear ratio between the rotating elements of the differential mechanism, and another example of the limit of the rotation is realized. In any case, if the engagement mechanism is in the engaged state, a transmission mode of the hybrid vehicle is the fixed gear ratio mode in which a transmission gear ratio, which is a ratio between number of engine revolutions and number of revolutions of the drive shaft is fixed.

According to the hybrid vehicle control apparatus of the present invention, in fixed gear ratio engine brake traveling, it is determined by the determining device whether or not the direction of the torque acting on the one engaging element coupled with the one rotating element (hereinafter referred to as “engagement torque”) is reversed. Whether or not the direction of the engagement torque is reversed is influenced dominantly by an engine operating condition. It is therefore possible to determine a determination reference or criterion referred to when the determining device performs the determination operation, experimentally, experientially, or theoretically in advance.

Here, in the hybrid vehicle control apparatus according to the present invention, the controlling device is configured to temporarily release the shutdown control if it is determined that the direction of the torque is reversed, so that the electrical rotating machine is returned from the shutdown state. Moreover, the controlling device is configured in such a manner that the backlash elimination torque is supplied from the electrical rotating machine that is returned from the shutdown state. The backlash elimination torque is positive or negative torque for eliminating the backlash formed between the pair of engaging elements. During the supply of the backlash elimination torque, the one engaging element is pressed against the other engaging element (or fixed element) to eliminate the backlash, so that there is no vibration and noise caused by rattling.

Therefore, according to the hybrid vehicle control apparatus of the present invention, it is possible to preferably suppress the vibration and noise caused by the rattling in the fixed gear ratio engine brake traveling.

Moreover, as described by the term “temporarily”, in the hybrid vehicle control apparatus according to the present invention, the release of the shutdown control is not permanent at least at a release time point. In other words, there are some cases where after the release of the shutdown control, it is subsequently required to return from the fuel cut and to change to a CVT mode, by which the release of the shutdown control can be accordingly continued; however, the shutdown control is basically directed to be continued in the fixed gear ratio engine brake traveling.

Therefore, in the hybrid vehicle control apparatus according to the present invention, the suppression of the vibration and noise caused by the rattling has as small influence on an effect of saving power consumption by the shutdown control as possible. In other words, there is provided a practically useful effect, which is to suppress the vibration and noise while saving the power consumption.

In one aspect of the hybrid vehicle control apparatus according to the present invention, said determining device determines that the direction of the torque is reversed in a case where a predetermined extent of torque pulsation occurs in the engine (claim 2).

The engine generates positive torque when a gas compressed in a compression stroke is expanded in an expansion stroke. In other words, the engine torque periodically pulsates in a process of reciprocating motion of a piston. The period of the pulsation is, for example, in the case of an in-line four cylinder engine, a crank angle of 180 degrees. Characteristics of the pulsation of the engine torque do not change even during the fuel cut.

Therefore, if the positive torque periodically generated in the process of the pulsation of the engine torque overcomes the friction torque of the engine (or negative torque) acting basically as the engagement torque in the fixed gear ratio engine brake traveling, the direction of the engagement torque is temporarily reversed.

According to this aspect, it is possible to relatively accurately determine whether or not the direction of the engagement torque is reversed, for example, by establishing a condition in which the predetermined extent of torque pulsation occurs in the engine, experimentally, experientially, or theoretically in advance, or by performing similar actions.

In this aspect, the case where the predetermined extent of torque pulsation occurs in the engine can be at least one of a case where number of revolutions of the engine corresponds to a predetermined rotation region, a case where a cylinder air amount is greater than or equal to a predetermined amount, and a case where temperature of lubricating oil is greater than or equal to a predetermined value (claim 3).

For example, if the number of engine revolutions corresponds to a resonance region, the torque pulsation relatively increases. Moreover, if a cylinder has a large intake air amount, the positive torque becomes larger in the expansion stroke, by which the torque pulsation relatively increases. Moreover, the lubricating oil is high-temperature, friction decreases, by which the torque pulsation is relatively easily actualized. It is therefore possible to relatively accurately determine whether or not the predetermined extent of torque pulsation occurs by comparing those various reference values with preset determination reference values.

In another aspect of the hybrid vehicle control apparatus according to the present invention, the backlash elimination torque can be supplied in a direction in which friction torque of the engine acts (claim 4).

According to this aspect, the backlash elimination torque is supplied in the direction in which the friction torque acts. The engagement torque acting on the one engaging element in the fixed gear ratio engine brake traveling is the friction torque of the engine from a time average viewpoint, and the backlash formed between the pair of engaging elements is basically eliminated in the direction in which the friction torque acts (i.e. in a negative torque direction).

Therefore, torque required when the backlash is eliminated by the backlash elimination torque is smaller when being supplied in the negative torque direction, which is the same direction as that of the friction torque, than when being supplied in a positive torque direction countering that of the friction torque. In other words, according to this aspect, it is possible to efficiently eliminate the backlash.

In another aspect of the hybrid vehicle control apparatus according to the present invention, said determining device can determine that the direction of the torque is reversed if an accelerator-on operation is performed (claim 5).

If the accelerator-on operation is performed, the engine brake traveling is stopped, and normal engine drive traveling in the fixed gear ratio mode is started. In this case, the engine, which is passively rotated by a driving force from the drive wheels, is actively rotated by spontaneous engine torque after the return from the fuel cut, and drives the drive wheels. As a result, the direction of the engagement torque is reversed.

According to this aspect, it is determined that the torque direction is reversed if the accelerator-on operation is performed, and the backlash elimination torque is supplied. It is therefore possible to suppress the vibration and noise caused by the rattling associated with the accelerator-on operation.

If the accelerator-on operation is performed, the fuel cut of the engine is released, but the backlash elimination by the backlash elimination torque is supplied to be completed at least before the engine torque after the release of the fuel cut acts on the one engaging element. Therefore, the release of the fuel cut is desirably performed after the completion of the backlash elimination. Moreover, the backlash elimination torque during the accelerator-on operation is desirably supplied in a direction in which the engine torque generated after the release of the fuel cut acts, i.e. in the positive torque direction.

Even if the accelerator-on operation is performed and the engine is returned from the fuel cut, in the case of an operating region in which the fixed gear ratio traveling is continued, the transmission mode is not transferred into the CVT mode. Therefore, at a timing at which it is determined that the engine torque increases to a value corresponding to the backlash elimination torque, the shutdown control can be restarted. In other words, even in this aspect, the temporal release of the shutdown control can be followed.

The nature, utility, and further features of this invention will be more clearly apparent from the following detailed description with reference to a preferred embodiment of the invention when read in conjunction with the accompanying drawings briefly described below.

### BRIEF DESCRIPTION OF THE DRAWINGS

FIG. 1 is a schematic configuration diagram conceptually illustrating a configuration of a hybrid vehicle in a first embodiment of the present invention;

FIG. 2 is a schematic configuration diagram conceptually illustrating a configuration of a hybrid drive apparatus;

FIG. 3A and FIG. 3B are operating nomograms explaining a fixed gear ratio mode;

FIG. 4A, FIG. 4B and FIG. 4C are schematic plan views of a dog clutch mechanism in the fixed gear ratio mode;

FIG. 5A, FIG. 5B and FIG. 5C are conceptual diagrams illustrating engagement torque reverse in fixed gear ratio engine brake traveling;

FIG. 6 is a flowchart illustrating backlash elimination control in the fixed gear ratio engine brake traveling;

FIG. 7 is a flowchart illustrating backlash elimination control in the fixed gear ratio engine brake traveling according to a second embodiment;

FIG. 8 is a schematic configuration diagram illustrating a power dividing mechanism in a modified example; and

FIG. 9 is an operating nomogram explaining a fixed gear ratio mode in the power dividing mechanism in FIG. 8.

### DETAILED DESCRIPTION OF THE PREFERRED EMBODIMENT

### Embodiments of the Invention

Hereinafter, preferred various embodiments of the present invention will be explained with reference to the drawings.

### First Embodiment

### Configuration of Embodiment

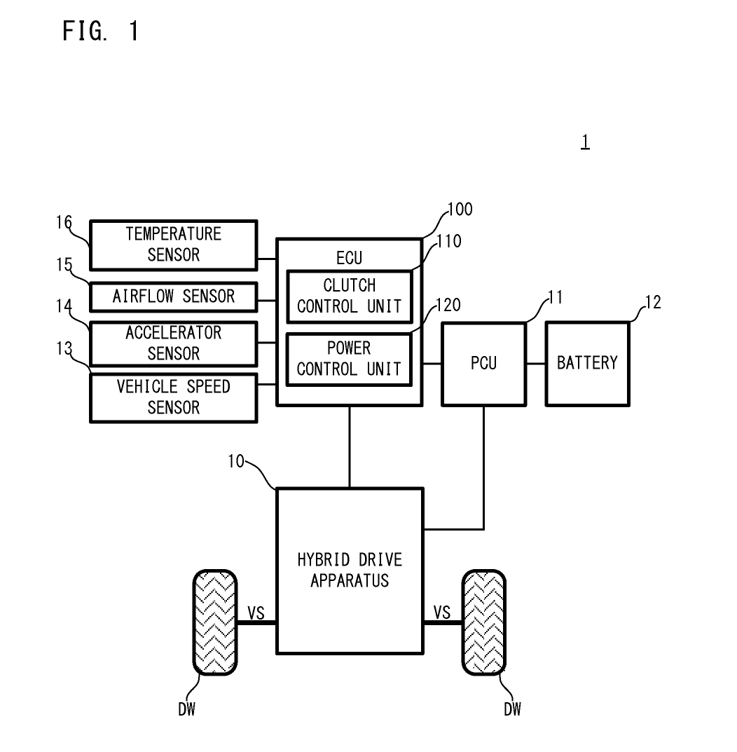

Firstly, with reference to FIG. 1, a configuration of a hybrid vehicle 1 according to a first embodiment of the present invention will be explained. FIG. 1 is a schematic configuration diagram conceptually illustrating the configuration of the hybrid vehicle 1.

In FIG. 1, the hybrid vehicle 1 is one example of the “hybrid vehicle” according to the present invention, provided with an electronic control unit (ECU) 100, a power control unit (PCU) 11, a battery 12, a vehicle speed sensor 13, an accelerator opening sensor 14, an airflow sensor 15, a temperature sensor 16, and a hybrid drive apparatus 10.

The ECU 100 is provided with a central processing unit (CPU), a read only memory (ROM), a RAM or the like, and is an electronic control unit configured to control operation of each unit of the hybrid vehicle 1. The ECU 100 is one example of the “hybrid vehicle control apparatus” according to the present invention. The ECU 100 is configured to perform various controls including backlash elimination control in fixed gear ratio engine brake traveling described later, in accordance with a control program stored in the ROM.

The ECU 100 is provided with a clutch control unit 110 and a power control unit 120. The clutch control unit 110 is an apparatus configured to control an operating state of a dog clutch mechanism 500 described later. Moreover, the power control unit 120 is an apparatus configured to control operating states of an engine 200, a motor generator MG1, and a motor generator MG2 described later. The control units operate in accordance with respective control programs set in advance, and control an operating state of the hybrid vehicle 1 in cooperation with each other, as occasion demands, together with another control unit not illustrated. In the backlash elimination control in the fixed gear ratio engine brake traveling described later, the power control unit 120 performs the control in cooperation with the clutch control unit 110 as occasion demands. Such a configuration of the ECU 100, however, is merely one example.

The PCU 11 includes a boost converter, an inverter for MG1, an inverter for MG2, and the like (all of which are not illustrated as they have a known configuration) configured to convert direct-current (DC) power extracted from the battery 12 to alternating-current (AC) power and supply it to the motor generator MG1 and the motor generator MG2, and configured to convert AC power generated by the motor generator MG1 and the motor generator MG2 to DC power and supply it to the battery 12. The PCU 11 is a control unit configured to control the input/output of electric power between the battery 12 and each motor generator, or the input/output of electric power between the motor generators. The PCU 11 is electrically connected to the ECU 100, and the operation of the PCU 11 is controlled by the ECU 100.

The battery 12 is a chargeable storage battery device that functions as an electric power supply associated with the electric power for performing power running of the motor generator MG1 and the motor generator MG2. The battery 12 has, for example, such a configuration that several hundreds of secondary battery unit cells with an output voltage of several V (volt) are connected in series.

The vehicle speed sensor 13 is a sensor configured to detect a vehicle speed V of the hybrid vehicle 1. The vehicle speed sensor 13 is electrically connected to the ECU 100, and the detected vehicle speed V is referred to by the ECU 100 as occasion demands.

The accelerator opening sensor 14 is a sensor configured to detect an accelerator opening degree Ta, which is a manipulated variable or operation amount of a not-illustrated accelerator pedal of the hybrid vehicle 1. The accelerator opening sensor 14 is electrically connected to the ECU 100, and the detected accelerator opening degree Ta is referred to by the ECU 100 as occasion demands.

The airflow sensor 15 is a sensor configured to detect an intake air amount Ga of the engine 200 described later. The airflow sensor 15 is electrically connected to the ECU 100, and the detected intake air amount Ga is referred to by the ECU 100 as occasion demands.

The temperature sensor 16 is a sensor configured to detect lubricating oil temperature Toil, which is temperature of lubricating oil of the engine 200 described later. The temperature sensor 16 is electrically connected to the ECU 100, and the detected lubricating oil temperature Toil is referred to by the ECU 100 as occasion demands.

The sensors exemplified herein are merely one part of a sensor group of the hybrid vehicle 1.

The hybrid drive apparatus 10 is a power train of the hybrid vehicle 1. The hybrid drive apparatus 10 is configured to transmit power supplied from the engine 200, and the motor generators MG1 and MG2 described later, to an axle VS coupled with drive wheels DW.

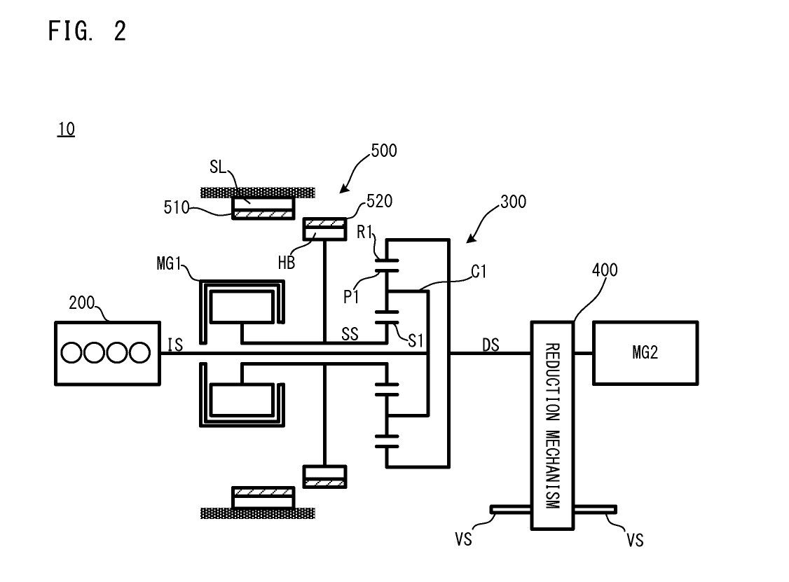

Now with reference to FIG. 2, a detailed configuration of the hybrid drive apparatus 10 will be explained. FIG. 2 is a schematic configuration diagram conceptually illustrating the configuration of the hybrid drive apparatus 10. In FIG. 2, the same parts as those in FIG. 1 will carry the same reference numeral, and the explanation thereof will be omitted as occasion demands.

In FIG. 2, the hybrid drive apparatus 10 is provided with the engine 200, a power dividing mechanism 300, the motor generator MG1, the motor generator MG2, a reduction mechanism 400, and a dog clutch mechanism 500.

The engine 200 is a gasoline engine, which is one example of the “engine” according to the present invention, and is configured to function as one power source of the hybrid vehicle 1. The engine 200 is provided with an injector (not illustrated) for fuel injection, and known fuel-cut control in which fuel injection via the injector is stopped is performed in the fixed gear ratio engine brake traveling described later.

The “engine” of the present invention is a concept that includes an engine configured to change thermal energy associated with combustion of fuel into kinetic energy and extract it. As long as the concept can be satisfied, the configuration of the engine according to the present invention may have various aspects, regardless of whether or not the configuration is known. Output power of the engine 200 via a not-illustrated crankshaft, engine torque Te, is inputted to an input shaft IS of the hybrid drive apparatus 10.

Back to FIG. 2, the motor generator MG1 is a motor generator, which is one example of the “electrical rotating machine” according to the present invention, and is configured to include a power running function for converting electric energy into kinetic energy and a regenerative function for converting kinetic energy into electric energy.

The motor generator MG2 is a motor generator. As in the motor generator MG1, the motor generator MG2 is configured to include the power running function for converting electric energy into kinetic energy and the regenerative function for converting kinetic energy into electric energy. Each of the motor generators MG1 and MG2 is configured, for example, as a three-phase synchronous motor generator, and is provided with a rotor having a plurality of permanent magnets on an outer circumferential surface, and a stator around which a three-phase coil for forming a rotating magnetic field is wound. The motor generators, however, may have another configuration.

The power dividing mechanism 300 is a planetary gear mechanism, which is one example of the “differential mechanism” according to the present invention, provided with a sun gear S1 disposed in a central part, a ring gear R1 concentrically disposed on an outer circumference of the sun gear S1, a plurality of pinion gears P1 disposed between the sun gear S1 and the ring gear R1, wherein the pinion gears P1 revolve while rotating on the outer circumference of the sun gear S1, and a planetary carrier C1 pivotally supporting rotating shafts of the respective pinion gears. Each of the rotating elements, which are the sun gear S1, the ring gear R1 and the planetary carrier C1, respectively function as differential elements of the power dividing mechanism 300.

The sun gear S1 is coupled with the motor generator MG1 via a sun gear shaft SS, and the number of revolutions thereof is equivalent to number of MG1 revolutions Ng, which is the number of revolutions of the motor generator MG1. The number of MG1 revolutions Ng is calculated by performing time processing of a rotation angle of the motor generator MG1, which is detected by a resolver (or rotation sensor) not illustrated in FIG. 1 and FIG. 2.

The ring gear R1 is coupled with the axle VS via the reduction mechanism 400 including various reduction gears, such as a drive shaft DS and a differential gear. Thus, number of revolutions of the ring gear R1 and number of drive shaft revolutions Nds, which is the number of revolutions of the drive shaft DS, take unique values with respect to the vehicle speed V. Since the motor generator MG2 is also coupled with the drive shaft DS, the number of drive shaft revolutions Nds is also equivalent to number of MG2 revolutions Nm, which is the number of revolutions of the motor generator MG2. Necessarily, the number of MG2 revolutions Nm also takes a unique value with respect to the vehicle speed V. The number of MG2 revolutions Nm is calculated by performing time processing of a rotation angle of the motor generator MG2, which is detected by a resolver (or rotation sensor) not illustrated in FIG. 1 and FIG. 2.

Here, the motor generator MG2 is directly coupled with the drive shaft DS; however, a transmission apparatus and a reduction apparatus may be also installed between the drive shaft DS and the motor generator MG2.

The planetary carrier C1 is coupled with the aforementioned input shaft IS. Therefore, the number of revolutions of the planetary carrier C1 is equivalent to number of engine revolutions Ne.

The power dividing mechanism 300 is configured to distribute the engine torque Te to the sun gear S1 and the ring gear R1 via the planetary carrier C1 and the pinion gears P1 at a predetermined ratio (or a ratio according to a gear ratio between the respective gears) under such a configuration.

At this time, if, in order to make it easy to understand the operation of the power diving mechanism 300, a gear ratio is defined as the number of teeth of the sun gear S1 to the number of teeth of the ring gear R1, then, sun gear shaft torque Tes acting on the sun gear S1 when the engine torque Te acts on the planetary carrier C1 from the engine 200 can be expressed by the following equation (1), and _drive shaft transmission torque Tep that appears on the drive shaft DS can be expressed by the following equation (2).

Tes=Te×/(1+) (1)

Tep=Te×1/(1+) (2)

The dog clutch mechanism 500 is a rotary meshing type clutch apparatus, which is one example of the “engagement mechanism” according to the present invention, provided with a plurality of engaging elements and configured in such a manner that the plurality of engaging elements can engage with or can be disengaged or released from each other.

The dog clutch mechanism 500 is provided, as a pair of engaging elements, with an annular sleeve SL, which is one example of the “other engaging element” according to the present invention, and a hub HB, which is one example of the “one engaging element” according to the present invention, wherein the annular sleeve SL is fixed in a relatively non-rotatable manner with respect to a fixed element such as, for example, a chassis and a transmission case, and the hub HB is fixed on the sun gear SS and rotates integrally with the sun gear shaft SS. The sleeve SL and the hub HB are coaxially arranged with each other. Moreover, rectangular dog teeth 510 are formed at equal intervals on an inner circumferential surface of the sleeve SL, and rectangular dog teeth 520 are formed at equal intervals on an outer circumferential surface of the hub HB.

The sleeve SL can be stroked by a predetermined amount in an axial direction by a not-illustrated actuator that is driven and controlled by the clutch control unit 110 of the ECU 100. If a stroke amount Ssl of the sleeve SL reaches a predetermined engagement stroke amount, the dog teeth 510 formed on the sleeve SL and the dog teeth 520 formed on the hub HB mesh with each other to make the dog clutch mechanism 500 in an engaged state. In the engaged state, the hub HB is fixed to the fixed element via the sleeve SL, and the sun gear shaft SS is thus locked to be non-rotatable. Necessarily, the motor generator MG1 becomes in a non-rotatable, locked state. In other words, one example of the “state in which the rotation is limited” according to the present invention is realized.

If, however, the stroke amount Ssl does not reach the engagement stroke amount, the dog teeth are disengaged from each other, and the dog clutch mechanism 500 becomes in a disengaged state. In the disengaged state, the hub HB is not fixed to the fixed element via the sleeve SL, and the sun gear shaft SS thus can rotate. Necessarily, the motor generator MG1 also can rotate.

The dog clutch mechanism 500 is one example of the “engagement mechanism” according to the present invention, provided with the sleeve SL and the hub HB described above as the “pair of engaging elements of the meshing type” according to the present invention. The engagement mechanism according to the present invention, in effect, widely includes the engagement mechanism in which the pair of engaging elements engage with each other by meshing with each other.

### Operation of Embodiment

### Outline of CVT Mode

The hybrid vehicle 1 has a continuously variable transmission (CVT) mode and a fixed gear ratio mode, as a transmission mode for defining a transmission gear ratio, which is a ratio between the number of engine revolutions Ne and the number of drive shaft revolutions Nds, which is the number of revolutions of the drive shaft DS (i.e. having a unique relation with the vehicle speed V). The former is a transmission mode when the dog clutch mechanism 500 is in the disengaged state, and the latter is a transmission mode when the dog clutch mechanism 500 is in the engaged state (i.e. when the motor generator MG1 is locked).

The power dividing mechanism 300 is a differential mechanism with two rotational degrees of freedom established by three rotating elements that are in a differential relation with each other, and is configured in such a manner that if the number of revolutions of two of the three elements are determined, the number of revolutions of the remaining one rotating element is necessarily determined. In other words, there is a high degree of freedom in a combination of operating points other than an operating point on the side of the drive shaft DS having a unique relation in the vehicle speed V (or an operating point of the motor generator MG2), i.e. a combination of operating points of the engine 200 and the motor generator MG1.

On the other hand, in order to supply the aforementioned drive shaft transmission torque Tep to the drive shaft DS if the engine 200 outputs the engine torque Te, it is necessary to compensate for reaction torque having a same absolute value as that of the aforementioned sun gear shaft torque Tes and having an inverted sign (which is negative torque as the engine torque is positive torque). In the CVT mode, the reaction torque is compensated for by the motor generator MG1. In other words, in the CVT mode, for the motor generator MG1, the operating point of the engine 200 (or a combination of the engine torque Te and the number of engine revolutions Ne) is controlled to be continuously variable by the control of the number of MG1 revolutions Ng and the MG1 torque Tg, which is the reaction torque.

<Details of Fixed Gear Ratio Mode>

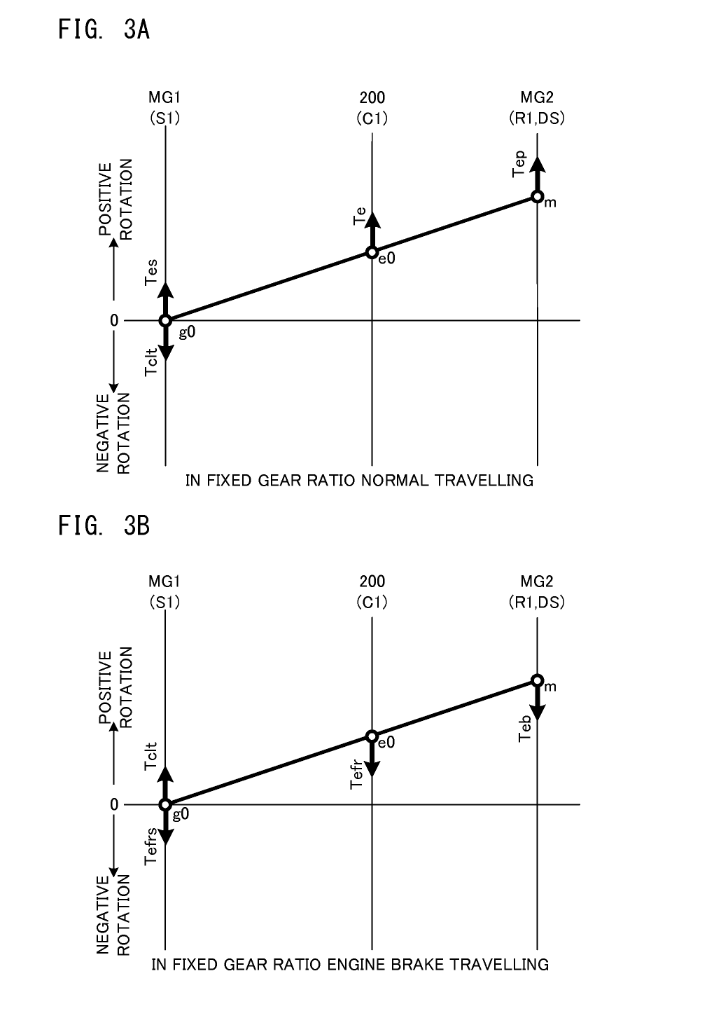

Now, with reference to FIG. 3A and FIG. 3B, the fixed gear ratio mode will be explained. FIG. 3A and FIG. 3B are operating nomograms of the hybrid drive apparatus 10 in the fixed gear ratio mode. In FIG. 3A and FIG. 3B, the same parts as those in FIG. 2 will carry the same reference numeral, and the explanation thereof will be omitted as occasion demands.

In FIG. 3A and FIG. 3B, the operating nomograms are charts illustrating a relation between the number of revolutions (on vertical axis) and the torque, regarding the three elements, which are the motor generator MG1 (or uniquely the sun gear S1), the engine 200 (or uniquely the planetary carrier C1), and the motor generator MG2 (or uniquely the ring gear R1 and the drive shaft DS). When explaining FIG. 3A and FIG. 3B, points on the operating nomograms are conveniently expressed as “operating points”.

FIG. 3A illustrates an operating nomogram in normal traveling in the fixed gear ratio mode (hereinafter expressed as “in fixed gear ratio normal traveling” as occasion demands). In FIG. 3A, if the dog clutch mechanism 500 becomes in the engaged state in which the sleeve SL and the hub HB as the meshing type engaging elements engage with each other and if the motor generator MG1 is locked to be non-rotatable, the operating point of the motor generator MG1 is fixed at an illustrated operating point g0 corresponding to the number of MG1 revolutions Ng=0.

An operating point m of the motor generator MG2, however, is uniquely determined from the vehicle speed V at that time point, and the operating point of the remaining engine 200 is thus uniquely determined by a differential action of the power dividing mechanism 300 and become an illustrated operating point e0. As described above, the transmission gear ratio becomes constant in the fixed gear ratio mode.

In the fixed gear ratio mode, the degree of freedom in the number of engine revolutions Ne with respect to the vehicle speed V is lost, whereas the dog clutch mechanism 500 can receive or bear the reaction torque for the sun gear shaft torque Tes, which appears on the sun gear shaft SS when the engine torque Te is supplied from the engine 200. FIG. 3A illustrates that clutch torque Tclt of the dog clutch mechanism 500 (Tclt<0) balances with the sun gear shaft torque Tes.

Since the dog clutch mechanism 500 is a mechanism configured to fix an engagement target to the fixed element, the dog clutch mechanism 500 does not spontaneously supply torque, and strictly speaking, it merely provides reaction force in response to the sun gear shaft torque Tes. In the embodiment, however, the clutch torque Tclt as the reaction torque is defined in order to make the explanation easy.

As described above, in the fixed gear ratio mode, the drive of the motor generator MG1 is not required when the drive shaft transmission torque Tep is supplied to the drive shaft DS. Therefore, in the fixed gear ratio normal traveling, the motor generator MG1 is controlled to be in a shutdown state in which switching drive of switching elements corresponding to respective three phases of the inverter for MG1 is stopped (or simply speaking, electrification is stopped) in a state of MG1 torque Tg=0. This control will be hereinafter expressed as “shutdown control”. The implementation of the shutdown control reduces electrical loss of a power conversion system including the motor generator MG1 and the inverter, thereby improving energy efficiency of the hybrid vehicle 1.

On the other hand, FIG. 3B illustrates an operating nomogram in fixed gear ratio engine brake traveling. The fixed gear ratio engine brake traveling means engine brake traveling in the fixed gear ratio mode. The fixed gear ratio engine brake traveling is performed if coasting deceleration is required, for example, by performing an accelerator-off operation or the like in the fixed gear ratio normal traveling. The fixed gear ratio engine brake traveling is realized by setting the engine 200 in a fuel-cut state and by supplying the drive shaft DS with engine brake torque Teb using rotational resistance of the engine 200.

The engine brake torque Teb is negative torque obtained by substituting, instead of the engine torque Te, engine friction torque Tefr (Tefr<0) in the above equation (2) representing the drive shaft transmission torque Tep. The engine friction torque Tefr is torque corresponding to the rotational resistance (which alternatively may be expressed as rotational inertia) of the engine 200 in the fuel-cut state. The engine friction torque Tefr increases with increasing the number of engine revolutions Ne.

Here, due to the configuration of the power dividing mechanism 300, the drive shaft transmission torque Tep does not act on the drive shaft DS unless the reaction torque countering the sub gear shaft torque Tes is received or born. The same applies even in the engine brake traveling. Therefore, in the fixed gear ratio engine brake traveling, the dog clutch mechanism 500 receives or bears the aforementioned clutch torque Tclt, as the reaction torque (i.e. positive torque in this case) for sun gear shaft brake torque Tefrs (i.e. negative torque), which is obtained by substituting, instead of the engine torque Te, the engine friction torque Tefr in the above equation (1) representing the sun gear shaft torque Tes. The fixed gear ratio engine brake traveling is performed in this manner.

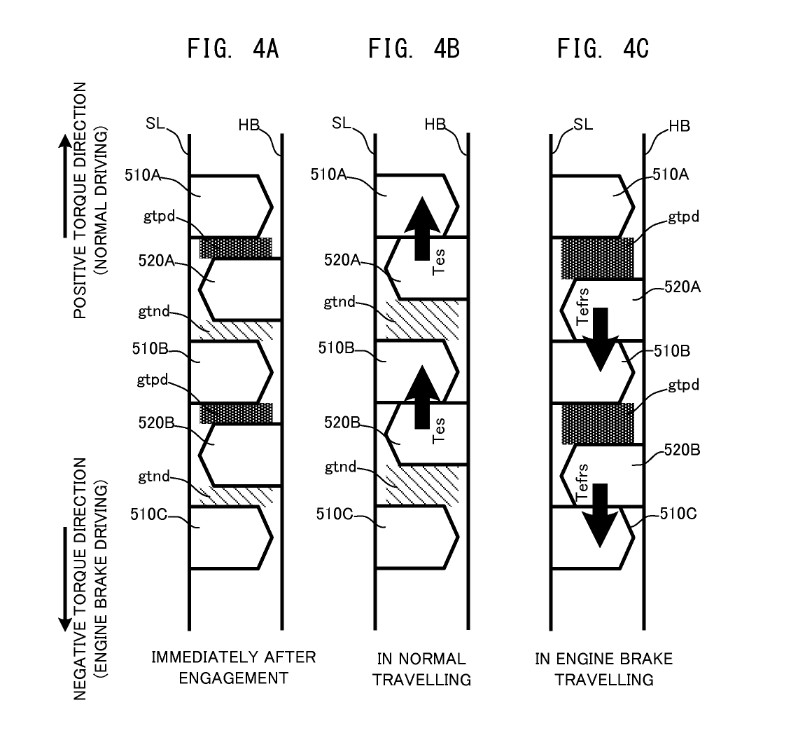

Now, with reference to FIG. 4A, FIG. 4B and FIG. 4C, the operating state of the dog clutch mechanism 500 in the fixed gear ratio traveling will be explained. FIG. 4A, FIG. 4B and FIG. 4C are schematic plan views of the dog clutch mechanism 500 in the fixed gear ratio mode. In FIG. 4A, FIG. 4B and FIG. 4C, the same parts as those in FIG. 2 will carry the same reference numeral, and the explanation thereof will be omitted as occasion demands.

FIG. 4A illustrates a state immediately after the engagement of the sleeve SL and the hub HB. Immediately after the engagement of the sleeve SL and the hub HB, there remains backlash gt as a physical gap provided at a designing stage to improve an engagement performance of the sleeve SL and the hub HB, between the dog teeth 510 (with identifiers of A, B and so on applied in order to identify each of the dog teeth in FIG. 4A, FIG. 4B and FIG. 4C), which is a meshing element on the sleeve SL side, and the dog teeth 520 (with identifiers of A, B and so on applied in order to identify each of the dog teeth in FIG. 4A, FIG. 4B and FIG. 4C), which is a meshing element on the hub HB side. The backlash gt is classified into positive torque side backlash gtpd and negative torque side backlash gtnd, on the basis of the hub HB coupled with the sun gear S1 as one rotating element.

FIG. 4B illustrates a state in the fixed gear ratio normal traveling. In the fixed gear ratio normal traveling, the sun gear shaft torque Tes, which appears on the sun gear shaft SS correspondingly to the engine torque Te as described above, is transmitted to the hub HB, which is the engaging element on the rotating element (or sun gear S1) side. If the hub HB is rotated by the sun gear shaft torque Tes in an illustrated positive torque direction, the dog teeth 520 A, B and so on, which is a meshing member on the hub HB side, are respectively brought into contact into the dog teeth 510 A, B and so on, which is a meshing member on the sleeve SL side, and the positive torque side backlash gtpd disappears. In other words, the backlash is eliminated in the positive torque direction. If the elimination of the backlash is completed, the reception or bearing of the reaction torque by the dog clutch mechanism 500 is started, and the aforementioned fixed gear ratio normal traveling by the drive shaft transmission torque Tep is realized.

FIG. 4C illustrates a state in the fixed gear ratio engine brake traveling. In the fixed gear ratio engine brake traveling, the sun gear shaft brake torque Tefrs, which appears on the sun gear shaft SS correspondingly to the engine friction torque Teft as described above, is transmitted to the hub HB, which is the engaging element on the rotating element (or sun gear S1) side. If the hub HB is rotated by the sun gear shaft brake torque Tefrs in an illustrated negative torque direction, the dog teeth 520 A, B and so on, which is the meshing member on the hub HB side, are respectively brought into contact into the dog teeth 510 B, C and so on, which is the meshing member on the sleeve SL side, and the negative torque side backlash gtnd disappears. In other words, the backlash is eliminated in the negative torque direction. If the elimination of the backlash is completed, the reception or bearing of the reaction torque by the dog clutch mechanism 500 is started, and the aforementioned fixed gear ratio engine brake traveling by the engine brake torque Teb is realized.

<Outline of Backlash Elimination Control in Fixed Gear Ratio Engine Brake Traveling>

By the way, as opposed to in the fixed gear ratio normal traveling in which the engine 200 spontaneously outputs the positive torque and drives the drive wheels, the engine 200 in the fixed gear ratio engine brake traveling merely supplies the hub HB with the sun gear shaft brake torque Tefrs corresponding to the engine friction torque Tefr in the fuel-cut state, as engagement torque. Thus, in the fixed gear ratio engine brake traveling, the engagement torque is not necessarily stabilized.

In the engine 200 in the fuel-cut state, the positive engine torque Te is generated in a process in which an intake air compressed in a compression stroke is expanded in an expansion stroke. In other words, the engine torque Te is a type of pulsating torque. In the case of an in-line four cylinder engine, the period of pulsation is a crank angle of 180 degrees. In the actual fixed gear ratio engine brake traveling, the pulsation of the engine torque Te interferes with the friction torque Tefr. Therefore, the direction of the engagement torque acting on the hub HB is temporarily reversed, depending on a magnitude correlation between the engine torque Te and the friction torque Tefr.

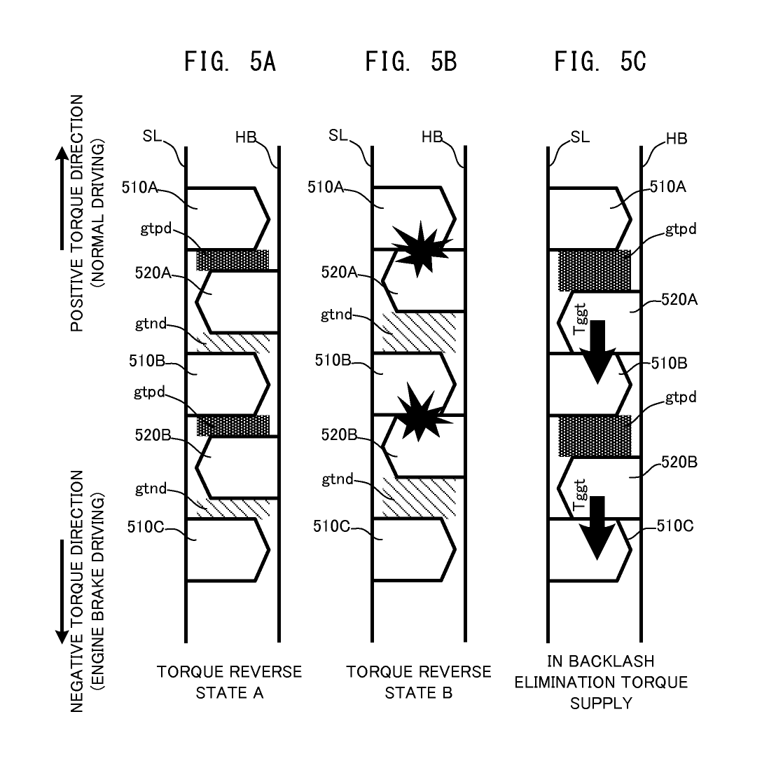

Now, with reference to FIG. 5A, FIG. 5B and FIG. 5C, the reverse of the direction of the engagement torque will be explained. FIG. 5A, FIG. 5B and FIG. 5C are conceptual diagrams illustrating the engagement torque reverse in the fixed gear ratio engine brake traveling. In FIG. 5A, FIG. 5B and FIG. 5C, the same parts as those in FIG. 4A, FIG. 4B and FIG. 4C will carry the same reference numeral, and the explanation thereof will be omitted as occasion demands.

5A illustrates one torque reverse state A and FIG. 5B illustrates another torque reverse state B.

In FIG. 5A, if an absolute value of the engine torque Te in the torque pulsation becomes equal to an absolute value of the sun gear shaft brake torque Tefr or slightly becomes greater than the sun gear shaft brake torque Tefr, the hub HB gradually moves in the positive torque direction to cause a torque-free state in which the backlash is not eliminated in both the positive and negative directions. This state is the reverse state A. In the reverse state A, the sub gear shaft brake torque Tefr overcomes the engine torque Te except in a time domain in which the positive engine torque Te is generated. Thus, the state in FIG. 5A and the state in FIG. 4C are repeated. In other words, the elimination of the backlash in the negative torque direction periodically occurs, and vibration and noise by rattling causes deterioration of drivability.

In FIG. 5B, if the absolute value of the engine torque in the torque pulsation is clearly greater than the absolute value of the sun gear shaft brake torque Tefr, the hub HB gradually moves in the positive torque direction to cause the positive torque direction backlash gtpd to disappear. In other words, the backlash is eliminated in the positive torque direction. This state is the reverse state B. Even in the reverse state B, the sub gear shaft brake torque Tefr overcomes the engine torque Te except in the time domain in which the positive engine torque Te is generated. Thus, the state in FIG. 5B and the state in FIG. 4C are repeated. In other words, the elimination of the backlash in the positive torque direction and the elimination of the backlash in the negative torque direction periodically occur, and the vibration and noise by the rattling causes the deterioration of drivability.

In order to prevent the vibration and noise by the rattling as described above, the backlash elimination control in the fixed gear ratio engine brake traveling is performed in the hybrid vehicle 1. In the backlash elimination control in the fixed gear ratio engine brake traveling, backlash elimination torque Tggt is outputted from the motor generator MG1, and the elimination of the backlash in the negative torque direction is forcibly performed. That is illustrated in FIG. 5C.

<Details of Backlash Elimination Control in Fixed Gear Ratio Engine Brake Traveling>

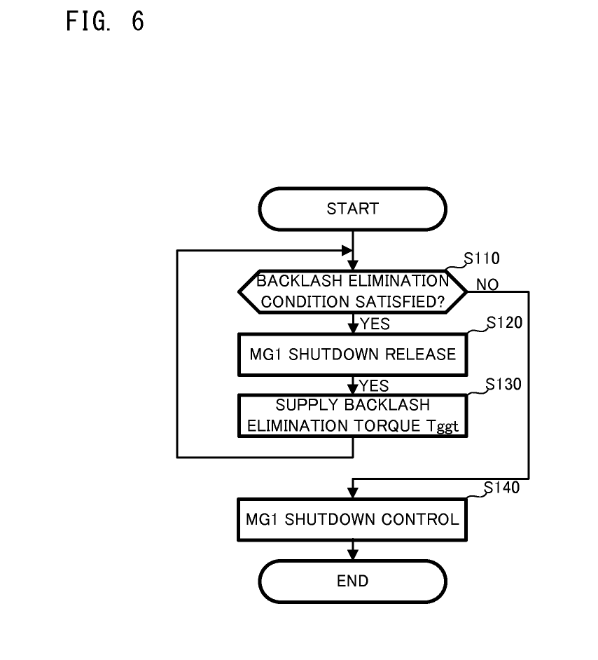

Next, with reference to FIG. 6, the details of the backlash elimination control in the fixed gear ratio engine brake traveling will be explained. FIG. 6 is a flowchart illustrating the backlash elimination control in the fixed gear ratio engine brake traveling. The backlash elimination control in the fixed gear ratio engine brake traveling is configured, as described above, to be performed by the power control unit 120 in cooperation with the clutch control unit 110 in the fixed gear ratio engine brake traveling.

In FIG. 6, firstly, it is determined whether or not a backlash elimination condition is satisfied (step S110). The backlash elimination condition is a condition in which the torque pulsation of the engine 200 becomes large enough to expect that the direction of the engagement torque is reversed as described above.

In the embodiment, there are three backlash elimination conditions (A) to (C) as follows; however, the three conditions merely one example.

Condition (A): Number of engine revolutions Ne satisfies Nell≦Ne≦Neul

Condition (B): Cylinder intake air amount Gacyl satisfies Gacyl≧Gacylth

Condition (C): Lubricating oil temperature Toil satisfies Toil≧Toilth

In the condition (A), Nell is lower limit number of revolutions, and Neul is upper limit number of revolutions. A number-of-revolutions region between the lower limit number of revolutions Nell and the upper limit number of revolutions Neul is a number-of-revolutions region in which it is found that the pulsation of the engine torque Te is larger than in another number-of-revolutions region, experimentally in advance. In this number-of-revolutions region, the vibration and noise of the engine 200 is amplified. This type of number-of-revolutions region is a value unique to each engine.

In the condition (B), Gacyl is the amount of the intake air sucked into each cylinder of the engine 200. The cylinder intake air amount Gacyl is calculated in a known method from numerical values such as the intake air amount Ga obtained from the airflow sensor 15, a throttle opening degree of the engine 200, the number of engine revolutions Ne, and an intake pipe negative pressure. If there is a relatively large amount of air sucked into the cylinder (or an air-fuel mixture), there will be also relatively large positive torque generated in the expansion stroke. Therefore, the torque pulsation of the engine 200 has a relatively large scale. A determination reference value Gacylth used for comparison with the cylinder intake air amount Gacyl is determined, experimentally in advance, as a value at which the engine 200 likely has the torque pulsation large enough to cause the reverse of the engagement torque described above.

In the condition (C), the lubricating oil temperature Toil is the temperature of the lubricating oil of the engine 200. Since the lubricating oil has higher viscosity with decreasing temperature, the engine 200 has larger friction as the lubricating oil has lower temperature. If the friction torque becomes larger, an influence of the pulsation of the engine torque Te is relatively hardly actualized or surfaced. In other words, the reverse of the engagement torque described above more easily occurs with increasing lubricating oil temperature Toil. A determination reference value Toilth used for comparison with the lubricating oil Toil is determined, experimentally in advance, as a value at which the engine 200 likely has the torque pulsation large enough to cause the reverse of the engagement torque described above.

In the step S110, if the backlash elimination condition is not satisfied (the step S110: NO), it is determined that the direction of the engagement torque acting on the hub HB is not reversed, and the shutdown control of the motor generator MG1 is continued (step S140).

On the other hand, if at least one of the aforementioned conditions (A) to (C) is satisfied and the backlash elimination condition is satisfied (the step S110: YES), the shutdown control of the motor generator MG1 is released (step S120).

If the shutdown control is released, the aforementioned backlash elimination torque Tggt is supplied from the motor generator MG1 (step S130). The backlash elimination torque Tggt is applied to the hub HB via the sun gear shaft SS.

Here, the backlash elimination torque Tggt, as explained in FIG. 5C, is relatively small torque for canceling the influence of the pulsation of the engine torque Te and continuing a backlash elimination state in the negative torque direction. The value of the backlash elimination torque Tggt is determined, experimentally in advance, in such a manner that the backlash elimination torque Tggt does not cause rattling shock and rattling sound.

The backlash elimination torque Tggt may be set as a fixed value at which the reverse of the engagement torque can be certainly prevented under various conditions, experimentally, experientially, or theoretically in advance. Alternatively, the backlash elimination torque Tggt may be a value that changes in a binary, stepwise, or continuous manner according to the various conditions described above.

Alternatively, since the engine friction torque Tefr increases with increasing the number of engine revolutions Ne, the influence of the torque pulsation becomes less with increasing the number of engine revolutions Ne. In view of this point, the backlash elimination torque Tggt may be set to a smaller value with increasing the number of engine revolutions Ne.

As explained above, according to the backlash elimination control in the fixed gear ratio engine brake traveling in the embodiment, if the engagement torque acting on the hub HB is possibly reversed (not necessarily actually reversed), the shutdown control of the motor generator MG1 is temporarily released. Then, the backlash elimination torque Tggt is supplied from the motor generator MG1. It is thus possible to prevent that the engagement torque acting on the hub HB is reversed and the dog teeth 520 on the hub HB side and the dog teeth 510 on the sleeve SL side intermittently collide with each other to cause the rattling shock and the rattling sound.

Moreover, in the embodiment, the backlash elimination torque Tggt is supplied in the negative torque direction, which is a direction in which the engine friction torque Tefr acts. The engagement torque in the fixed gear ratio engine brake traveling averagely acts in the negative torque direction, which is a direction in which the engine friction torque Tefr acts. It is therefore possible to save power consumption more in comparison with the case of the supply of the backlash elimination torque Tggt in the positive torque direction, by sharing the backlash elimination torque Tggt in the negative torque direction.

In FIG. 6, after the supply of the backlash elimination torque Tggt, the process is returned to the step S110. Therefore, if an operating condition of the engine 200 changes and none of the aforementioned conditions (A) to (C) is satisfied, the step S110 branches to the “NO” side and the shutdown control of the motor generator MG1 is restarted by the step S140. In other words, the shutdown control of the motor generator MG1 is temporarily stopped according to demand. Therefore, according to the embodiment, it is possible to prevent the vibration and noise by the rattling while maintaining the motor generator MG1 in the shutdown state as much as possible in the fixed gear ratio engine brake traveling.

### Second Embodiment

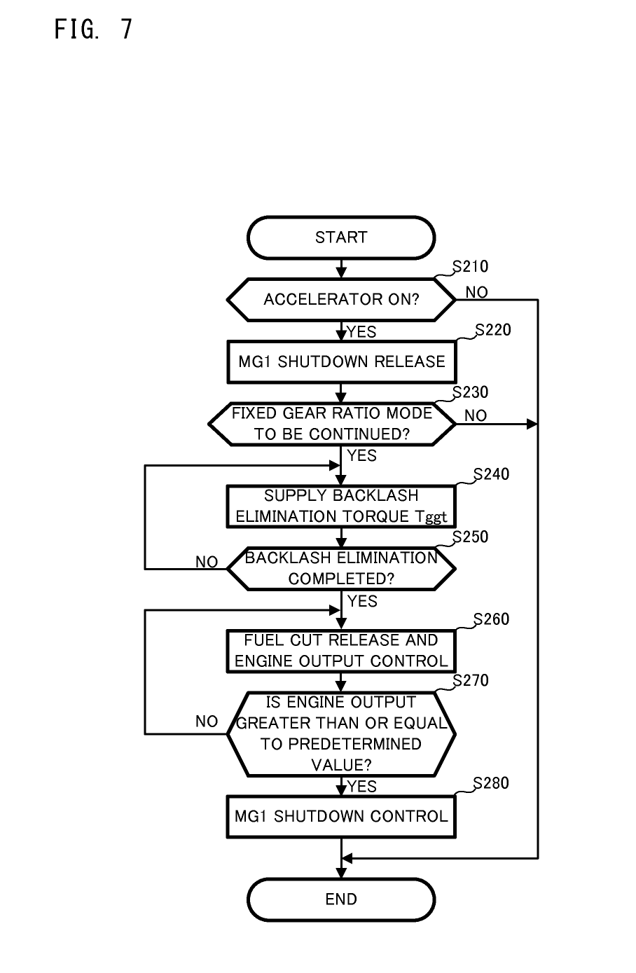

There is another condition for reversing the engagement torque acting on the hub HB, other than the condition related to the pulsation of the engine torque Te explained in the first embodiment. In a second embodiment, an explanation will be given to the backlash elimination control in the fixed gear ratio engine brake traveling corresponding to the torque reverse by such another condition. FIG. 7 is a flowchart illustrating the backlash elimination control in the fixed gear ratio engine brake traveling according to the second embodiment.

In FIG. 7, it is determined whether or not an accelerator-on operation is performed (step S210). If the accelerator-on operation is not performed (the step S210: NO), the backlash elimination control in the fixed gear ratio engine brake traveling is ended.

The accelerator-on operation is an engine brake traveling release request. Therefore, if the accelerator-on operation is performed in the fixed gear ratio engine brake traveling (the step S210: YES), the shutdown control of the motor generator MG1 is firstly released (step S220) in order to change the fixed gear ratio engine brake traveling to the fixed gear ratio normal traveling. The end of the engine brake traveling associated with the accelerator-on operation necessarily means the reverse of the engagement torque acting on the hub HB. In other words, the step S210 corresponds to one example of the aspect in which it is determined whether or not the engagement torque is reversed.

If the shutdown control is released, it is determined whether or not the fixed gear ratio mode is to be continued (step S230). The fixed gear ratio mode is performed in a case where the values of the vehicle speed V, required driving force Ft of the drive wheels and the like correspond to a fixed gear ratio mode selection area. If the numerical values correspond to another traveling mode selection area (e.g. CVT mode selection area), the fixed gear ratio mode is changed to another traveling mode. Incidentally, various known aspects can be applied to this type of traveling mode changing process. If the fixed gear ratio mode is not to be continued (the step S230: NO), the backlash elimination control in the fixed gear ratio engine brake traveling is ended.

If the fixed gear ratio mode is to be continued (the step S230: YES), the backlash elimination torque Tggt is supplied from the motor generator MG1 (step S240).

Here, the backlash elimination torque Tggt in the second embodiment, as opposed to the first embodiment, is supplied in the positive torque direction. This is because it is necessary to eliminate the backlash in the direction of the engagement torque corresponding to the fixed gear ratio normal traveling (i.e. in the positive torque direction) (i.e. to make the backlash gtpd disappear) as the direction of the engagement torque acting on the hub HB is reversed at a time point at which the accelerator-on operation is performed.

Since the magnitude of the engine friction torque Tefr varies depending on the number of engine revolutions Ne, the magnitude of the backlash elimination torque Tggt is determined to be greater by a predetermined amount than the sun gear shaft brake torque Tefrs, on the basis of the number of engine revolutions Ne. For example, the engine friction torque at that time point is calculated on the basis of a relation between the number of engine revolutions Ne and the engine friction torque Tefr, which is obtained experimentally, experientially, or theoretically in advance, and the sun gear shaft brake torque Tefrs is calculated on the basis of the aforementioned equation (1). The backlash elimination torque Tggt is determined to have an absolute value that is the absolute value of the sun gear shaft brake torque Tefrs+α (α is an adaptive value). For example, the adaptive value α is determined not to actualize the vibration and noise when the backlash gtrd is eliminated in the positive direction.

Moreover, as defined as the condition (C) in the first embodiment, the lubricating oil Toil has a relation with the engine friction torque Tefr. Therefore, the backlash elimination torque Tggt may be calculated by correcting a reference value required according to the engine friction torque Tefr, according to the lubricating oil temperature Toil, as occasion demands. Alternatively, the backlash elimination torque Tggt may be mapped by using both the number of engine revolutions Ne and the lubricating oil temperature Toil as parameters, to select a corresponding numerical map.

If the supply of the backlash elimination torque Tggt is started, it is determined whether or not the backlash elimination is completed (step S250).

Whether or not the backlash elimination is completed is determined on the basis of the number of MG1 revolutions Ng. In other words, if the backlash elimination is completed, the hub HB engages with the sleeve, so that the rotation of the hub HB is stopped. It is therefore possible to determine whether or not the backlash elimination is completed, on the basis of whether or not the number of MG1 revolutions, which is equivalent to the number of revolutions of the hub HB, becomes zero. At this time, it may be also referred to whether or not a change is stopped in a numerical value of a resolver configured to detect the rotation angle of the motor generator MG1. Moreover, if a relation between the magnitude of the backlash elimination torque Tggt and a time required for the backlash elimination is obtained experimentally in advance, it may be determined that the backlash elimination is completed when the time required for the backlash elimination elapses. While the backlash elimination is not completed (the step S250: NO), the supply of the backlash elimination torque Tggt is continued.

If the backlash elimination is completed (the step S250: YES), the fuel cut of the engine 200 is released, and an engine output Pe is controlled according to a required output value (step S260). As a result, the engine torque Te increases.

Then, it is determined whether or not the engine output Pe is greater than or equal to a predetermined value (step S270).

Now, the predetermined value of the engine output Pe will be explained.

When shutting down the motor generator MG1 again after the temporal release of the shutdown control, it is necessary to change the engagement torque for eliminating the positive direction backlash gtpd, which acts on the hub HB, from the MG1 torque Tg (which is the backlash elimination torque Tggt from the viewpoint of a control flow after the step S240) to the sun gear shaft torque Tes.

At this time, if the sun gear shaft torque Tes is less than the MG1 torque Tg, the engagement torque of the hub HB varies in the negative torque direction immediately after the shutdown of the motor generator MG1, and the vibration and noise possibly occur according to circumstances. It is therefore desirable that the shutdown control of the motor generator MG1 is restarted at a time point at which the sun gear shaft torque Tes increases to the MG1 torque Tg or more.

If, however, the sun gear shaft torque Tes is greater than the MG1 torque Tg, the hub HB is only pressed in the positive torque direction immediately after the restart of the shutdown control of the motor generator MG1, and there is no problem from the viewpoint of the vibration and noise. However, a period of the temporal release of the shutdown control of the motor generator MG1 is a time of the power consumption of the battery 12. Therefore, from the viewpoint of saving the power consumption, it is desirable that the shutdown control is restarted as quickly as possible.

From the above, the predetermined value of the engine output Pe is set to a value at which the sun gear shaft torque Tes substantially matches the MG1 torque Tg. If a required value of the sun gear shaft torque Tes is determined, a required value of the engine torque Te, so that the predetermined value of the engine output Pe can be determined from the required value of the engine torque Te and the number of engine revolutions Ne.

As opposed to the motor generator MG1 with high torque control accuracy, the engine 200 generally has low torque control accuracy. In particular, immediately after the return from the fuel cut, the engine torque is relatively unstable. Therefore, even if a target value of the engine torque Te is determined, it is not always easy to accurately detect whether or not the engine torque Te reaches the target value.

Thus, from this type of practical viewpoint, the determination process in the step S270 may be also replaced, for example, by any of the following alternative determination processes.

In other words, a first alternative determination process is performed on the basis of an elapsed time from the fuel cut release. Specifically, the determination that the engine output Pe reaches the predetermined value is established at a time point at which the elapsed time becomes greater than or equal to a predetermined time. The MG1 torque Tg outputted for the purpose of only the backlash elimination originally does not have a large absolute value. It is therefore possible to determine whether or not the engine torque Te reaches the required value, on the basis of the elapsed time from the fuel cut release. At this time, if this type of elapsed time is defined experimentally, experientially, or theoretically in advance, more accurate determination is possible.

A second alternative determination process is performed on the basis of an engine required output Pen after the fuel cut release. Specifically, the determination that the engine output Pe reaches the predetermined value is established at a time point at which the engine required output Pen becomes greater than or equal to a predetermined value. The predetermined value in this case may be also set, for example, to a value obtained by adding a safety-side margin to the required value of the engine output corresponding to the sun gear shaft torque Tes. Since the engine output Pe is controlled on the basis of the engine required output Pen, it is not hard to predict the engine output Pe at that time point on the basis of the engine required output Pen, at least in a torque range of the backlash elimination torque Tggt.

If the engine output Pe is less than the predetermined value (the step S270: NO), the process is returned to the step S260. If the engine output Pe increases to the predetermined value or more (the step S270: YES), the motor generator MG1 is controlled again to be in the shutdown state by the shutdown control (step S280). If the motor generator MG1 is returned to be in the shutdown state, the backlash elimination control in the fixed gear ratio engine brake traveling is ended.

As explained above, according to the backlash elimination control in the fixed gear ratio engine brake traveling in the second embodiment, it is possible to suppress the vibration and noise by the rattling if the accelerator-on operation is performed in the fixed gear ratio engine brake traveling and the change to the fixed gear ratio normal traveling is performed.

Moreover, even in the second embodiment, there is no change in the point that the shutdown control of the motor generator MG1 is temporarily released, and it is possible to suppress the vibration and noise while keeping the effect of saving the power consumption in the fixed gear ratio mode.

### Modified Example

The aforementioned various embodiments is configured in such a manner that the motor generator MG1 is fixed in the non-rotatable manner by the dog clutch mechanism 500. A practical aspect associated with a relation between the engagement mechanism and the differential mechanism according to the present invention, however, is not limited such a configuration. In other words, it is possible to change a lock target of the dog clutch mechanism 500 by changing the configuration of the power dividing mechanism as the differential mechanism according to the present invention, from the power dividing mechanism 300 described above. Now, a configuration and operation of such a power dividing mechanism 301 will be explained.

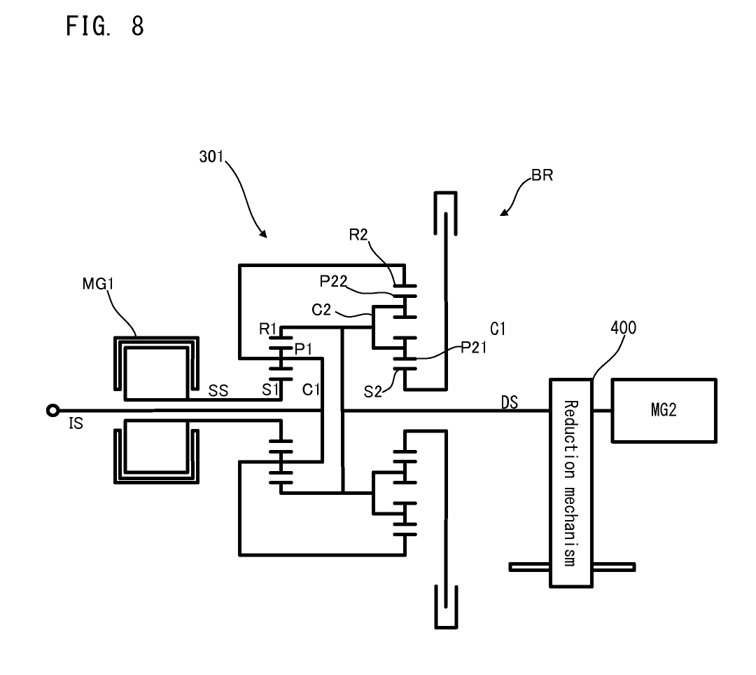

Firstly, with reference to FIG. 8, the configuration of the power dividing mechanism 301 will be explained. FIG. 8 is a schematic configuration diagram illustrating the power dividing mechanism 301. In FIG. 8, the same parts as those in FIG. 2 will carry the same reference numeral, and the explanation thereof will be omitted as occasion demands.

In FIG. 8, the power dividing mechanism 301 is provided with two pairs of differential mechanisms, and one differential mechanism (conveniently referred to as a first differential mechanism) has the same configuration as that of the power dividing mechanism 300, which is a single pinion gear type planetary gear mechanism in the first embodiment. In other words, the planetary carrier C1 is coupled with the input shaft IS, and the sun gear S1 is coupled with the sun gear shaft SS, and the ring gear R1 is coupled with the drive shaft DS.

On the other hand, the other differential mechanism (conveniently referred to as a second differential mechanism) is provided with a sun gear S2, a carrier C2, and a ring gear R2, which exhibit a differential action for each other, a pinion gear P21 meshing with the sun gear S2 and a pinion gear P22 meshing with the ring gear R2, which are respectively held by the carrier D2 so as to rotate on their own axes in an axial direction and to revolve by the rotation of the carrier C2. In other words, the other differential mechanism is configured as a so-called double pinion gear type planetary gear mechanism.

The first and second differential mechanisms are coupled with each other by coupling the ring gear R2 in the second differential mechanism with the carrier C1 in the first differential mechanism and by coupling the carrier C2 in the second differential mechanism with the ring gear R2 in the first differential mechanism. The power dividing mechanism 301 is a so-called Ravigneaux type planetary gear mechanism as a whole. The power dividing mechanism 301 is provided with four rotating elements in total, which are the sun gear S1, the carrier C1 and the ring gear R2, the ring gear R1 and the carrier C2, and the sun gear S2.

Now, in the modified example, the sun gear S2 in the second differential mechanism is configured to be coupled with the dog clutch mechanism 500. In other words, if the dog clutch mechanism 500 is in the engaged state, the sun gear S2 in the second differential mechanism is fixed in the non-rotatable manner.

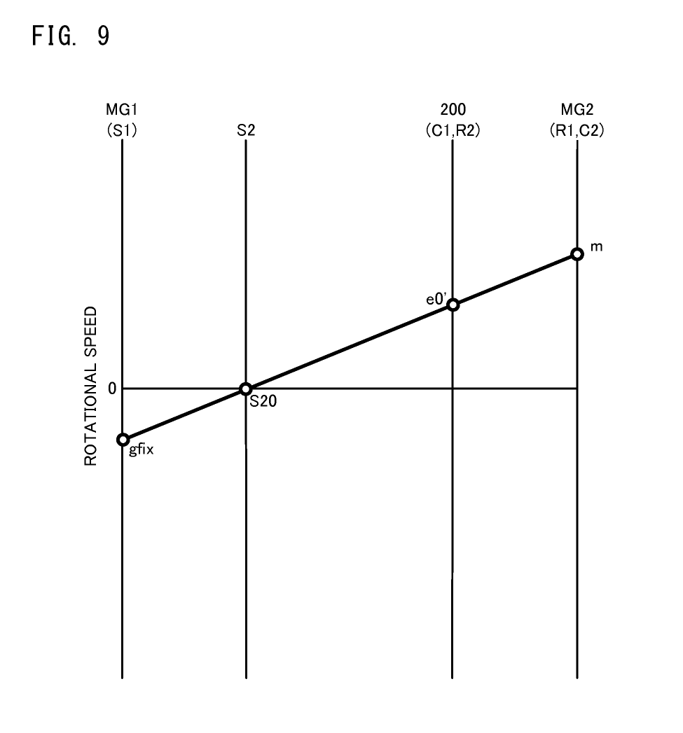

Here, in a state in which the sun gear S2 is fixed in the non-rotatable manner, the rotation of the motor generator MG1 is limited, and the number of MG1 revolutions Ng is substantially fixed to one vale. This will be explained with reference to FIG. 9. FIG. 9 is an operating nomogram corresponding to the state in which the sun gear S2 is locked in the power dividing mechanism 301. In FIG. 9, the same parts as those in FIG. 3 will carry the same reference numeral, and the explanation thereof will be omitted as occasion demands.

FIG. 9 illustrates, from the left, the motor generator MG1, the sun gear S2, the engine 200, and the motor generator MG2 (or uniquely the drive shaft DS). Moreover, FIG. 9 illustrates the operating nomogram in the state in which the sun gear S2 is locked by the dog clutch mechanism 500.

If the sun gear S2 is locked by the dog clutch mechanism 500 in a case where the operating point of the motor generator MG2 is an illustrated operating point m, the operating point of the sun gear S2 is fixed to an operating point S20 corresponding to zero rotation. The operating point of the engine 200 is necessarily fixed to an illustrated operating point e0′.

In this state, however, the operating point of the sun gear S1, which is the remaining differential element of the power dividing mechanism 301, is also fixed to an illustrated operating point gfix. In other words, although the motor generator MG1 is not directly locked by the dog clutch mechanism 500, the number of revolutions thereof is substantially fixed. This state is another example of the state in which “the rotation is limited” according to the present invention.

Even in the modified example, the reaction torque of the sun gear shaft torque Tes is received or born via the dog clutch mechanism 500. Thus, the fixed gear ratio mode is realized as in the various embodiments described above. Necessarily, in view of a gear ratio between the sun gear S2 and the sun gear S1 (which is namely that torque acting on the sun gear S2 in the case of the supply of the Mg1 torque Tg varies depending on the gear ratio), it is possible to apply the same control as the backlash elimination control in the fixed gear ratio engine brake traveling in the various embodiments described above.

The invention may be embodied in other specific forms without departing from the spirit or essential characteristics thereof. The present embodiments and examples are therefore to be considered in all respects as illustrative and not restrictive, the scope of the invention being indicated by the appended claims rather than by the foregoing description and all changes which come within the meaning and range of equivalency of the claims are therefore intended to be embraced therein.

### DESCRIPTION OF REFERENCE NUMERALS

1 hybrid vehicle
10 hybrid drive apparatus
100 ECU
110 clutch control unit
120 power control unit
200 engine
300 power dividing mechanism
MG1 motor generator
MG2 motor generator
500 dog clutch mechanism

1. A hybrid vehicle control apparatus configured to control a hybrid vehicle comprising:
an engine;
an electrical rotating machine;
a drive shaft connected to drive wheels;
a differential mechanism comprising a plurality of rotating elements that perform a differential action on each other, including rotating elements each of which is coupled with the engine, the electrical rotating element, or the drive shaft; and
an engagement mechanism comprising a pair of engaging elements of a meshing type, one of which is coupled with one of the plurality of rotating elements and another of which is coupled with a fixed element, the engagement mechanism realizing a fixed gear ratio mode in which rotation of the electrical rotating machine is limited in an engaged state in which the pair of engaging elements engage,
said hybrid vehicle control apparatus comprising:
a determining device configured to determine whether or not a direction of torque acting on the one engaging element is reversed if engine brake traveling with fuel cut of the engine is performed in the fixed gear ratio mode; and
a controlling device configured to control the electrical rotating machine to perform shutdown control for setting the electrical rotating machine to be in a shutdown state in the fixed gear ratio mode, and to temporarily release the shutdown control if it is determined that the direction of the torque is reversed, so that backlash elimination torque is supplied for eliminating backlash formed between the pair of engaging elements.

2. The hybrid vehicle control apparatus according to claim 1, wherein said determining device determines that the direction of the torque is reversed in a case where a predetermined extent of torque pulsation occurs in the engine.

3. The hybrid vehicle control apparatus according to claim 2, wherein the case where the predetermined extent of torque pulsation occurs in the engine is at least one of a case where number of revolutions of the engine corresponds to a predetermined rotation region, a case where a cylinder air amount is greater than or equal to a predetermined amount, and a case where temperature of lubricating oil is greater than or equal to a predetermined value.

4. The hybrid vehicle control apparatus according to claim 2, wherein the backlash elimination torque is supplied in a direction in which friction torque of the engine acts.

5. The hybrid vehicle control apparatus according to claim 1, wherein said determining device determines that the direction of the torque is reversed if an accelerator-on operation is performed.

6. The hybrid vehicle control apparatus according to claim 3, wherein the backlash elimination torque is supplied in a direction in which friction torque of the engine acts.
